(19) United States
(12) Patent Application Publication
(10) Pub. No.: US 2026/0284969 A1
(43) Pub. Date: Sep. 24, 2026

(54) Polyhedral Frame Structures

(71) Applicant: Nissan North America, Inc., Franklin, TN (US)

(72) Inventors: Takuro Iwata, Commerce Township, MI (US); Nanzhu Zhao, Farmington Hills, MI (US)

(21) Appl. No.: 19/086,584

(22) Filed: Mar. 21, 2025

(51) Int. Cl. B29C 64/165; B29K 105/20; B33Y 10/00; B33Y 70/10

(52) U.S. Cl. CPC B29C 64/165; B33Y 10/00; B33Y 70/10; B29K 2105/206; B29K 2995/0002

(57) ABSTRACT

A structure including a base layer comprising base polyhedral frame structures that are connected with each other at base layer wires of the base polyhedral frame structures; and a secondary layer comprising secondary polyhedral frame structures that are each connected with the base layer at connection wires of the base and secondary polyhedral frame structures The secondary polyhedral frame structures each have a secondary volume that is less than a base volume each of the base polyhedral frame structures.

### TECHNICAL FIELD

This disclosure relates to polyhedral frame structures arranged in layers and configured to insulate sound.

### BACKGROUND

The need for effective sound insulation has grown significantly in recent years due to concerns over noise pollution, comfort, and privacy. Noise transmission can result in discomfort, disruption of daily activities, and a decline in the quality of life. Consequently, there is a substantial demand for improved materials and structures that can efficiently reduce sound transmission, enhance acoustic performance, and provide a more comfortable environment.

Traditional methods of sound insulation often rely on materials such as fiberglass, foam, and mineral wool, which are positioned around structures to mitigate noise transmission. Despite their use, many conventional soundproofing solutions still exhibit limitations in terms of effectiveness, thickness, weight, temperature resistance, brittleness, and overall performance. Furthermore, they can be expensive, difficult to install, or susceptible to degradation over time.

Accordingly, what is needed are techniques and structures that are effective at insulating noise, easy to construct, and implementable in a wide range of applications.

### SUMMARY

Disclosed herein are implementations of a structure including a base layer including base polyhedral frame structures that are connected with each other at base layer wires of the base polyhedral frame structures. The structure includes a secondary layer including secondary polyhedral frame structures that are each connected with the base layer at connection wires of the base and secondary polyhedral frame structures, wherein the secondary polyhedral frame structures each have a secondary volume that is less than a base volume each of the base polyhedral frame structures.

In some examples, the base layer may have a base diameter that is larger than a secondary diameter of the secondary layer. The base diameter may be at least twice as large as the secondary diameter. The secondary polyhedral frame structures may be connected with each other within the secondary layer by overlapping secondary layer wires. The base layer wires and the secondary layer wires may each separately define layer facets that connect with the connection wires of the base and secondary polyhedral frame structures by intermediate wires. The base and secondary polyhedral frame structures may have a shape that is the same. The base and the secondary polyhedral frame structures may each have a shape that is symmetrical. The base and the secondary polyhedral frame structures may each comprise square and octagonal facets. The base and secondary polyhedral frame structures may each have a shape of a truncated octahedron. The structure may further include one or more subsequent layers each comprising subsequent polyhedral frame structures that are connected with the secondary layer or a preceding layer of the one or more subsequent layers by subsequent connection wires of the secondary polyhedral frame structures and/or the subsequent polyhedral frame structures. At least some of the subsequent polyhedral frame structures may have a subsequent volume that is less than the secondary volume of each of the secondary polyhedral frame structures.

Disclosed herein are implementations of a structure including a base layer that includes base polyhedral frame structures that are connected with each other within the base layer and one or more subsequent layers each comprising subsequent polyhedral frame structures that are connected with each other within individual layers of the one or more subsequent layers. Each of the individual layers of the one or more subsequent layers are connected with the base layer or a preceding layer of the one or more subsequent layers. The base layer and the one or more subsequent layers in combination define channels between connection, layer, and intermediate facets of base layer and the one or more subsequent layers having a tortuosity of greater than 1.

In some examples, the tortuosity may be measured as a distance between an initial facet of the base layer and a distal facet of a terminal layer of the one or more subsequent layers. The base layer may be a base diameter that is at least twice as large as a subsequent diameter of each of the one or more subsequent layers. The preceding layer of the one or more subsequent layers may have a preceding diameter that is at least twice as large as a succeeding diameter of a succeeding layer of the one or more subsequent layers. The base polyhedral frame structures may be connected with each other at the layer facets within the base layer, wherein the subsequent polyhedral frame structures are connected with each other at layer facets within each of the individual layers of one or more subsequent layers, and the base polyhedral frame structures and/or the one or more subsequent polyhedral frame structures may be connected with each other at connection facets that are partially located within the base layer and/or the one or more subsequent layers.

Disclosed herein are implementations of a method of additive manufacturing including curing a base layer that includes base polyhedral frame structures connected with each other at base layer wires. The method further includes curing one or more subsequent layers comprising subsequent polyhedral frame structures connected with each other at subsequent layer wires, wherein the one or more subsequent layers are connected with the base layer or a preceding layer of the one or more subsequent layers at connection wires of the base polyhedral frame structures and/or the subsequent polyhedral frame structures of the preceding layer. At least some of the one or more subsequent layers have a subsequent diameter that is less than a base diameter of the base layer.

In some examples, the base diameter may be at least twice as large as the subsequent diameter. The base layer wires and the subsequent layer wires may each separately define layer facets that form a pattern that is horizontally aligned. The base polyhedral frame structures and the subsequent polyhedral frame structures may have a shape that is symmetrical.

The polyhedral frame structures arranged in stacked layers form winding channels and/or voids therebetween that mitigate sound waves. Because different layers contain polyhedral frame structures of different diameters and volumes, the winding channels are inherently formed because some of the wires or facets of the polyhedral frame structures overlap between layers and cause obstructions to incoming sound waves. When assembled in a series of layers, the successive layers in combination insulate noise due to the formation of tortuous channels that cause sound waves to be bounced and muffled off of the wires and facets of the polyhedral frame structures. Additionally, since the layers contain uniform patterns or arrangements of polyhedral frame structures that are connected with other layers in a successive arrangement, each of the layers can be manufactured in a streamlined and effective manner.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of a structure.

FIG. 2A is a perspective view of a structure.

FIG. 2B is side view of the structure of FIG. 2A.

FIG. 3 illustrates an example technique to form the structure of FIGS. 1-2B.

### DETAILED DESCRIPTION

The present disclosure provides for a structure having polyhedral frame structures arranged in stacked layers that are configured to deflect sound waves. When arranged in a series of the stacked layers with differently sized polyhedral frame structures, the wires of the polyhedral frame structures define channels therebetween, and as sound travels through the polyhedral frame structures that have varying sizes within different layers of the stacked layers, the sound is deflected and/or bounced off of the wires such that the sound is mitigated or eliminated upon reaching the exit of the structure. With this arrangement, the structure can be used to insulate an area from loud sounds by being placed between a device (e.g., an engine) or area (e.g., a recording studio) that is producing sounds and an environment where quiet is desired.

Additionally, when the wires of polyhedral frame structures in adjacent layers have overlapping or connected surfaces, the structure can be assembled or built using additive manufacturing techniques, such as digital light processing (DLP) process or other additive manufacturing processes. Because the wires of adjacent layers connect or overlap, the additive manufacturing process can print a layer and build upon that layer, while only using the polyhedral frame structures. This can simplify the design and provide for a uniform technique to print a structure that insulates sound with low amounts of materials in the polyhedral frame structures.

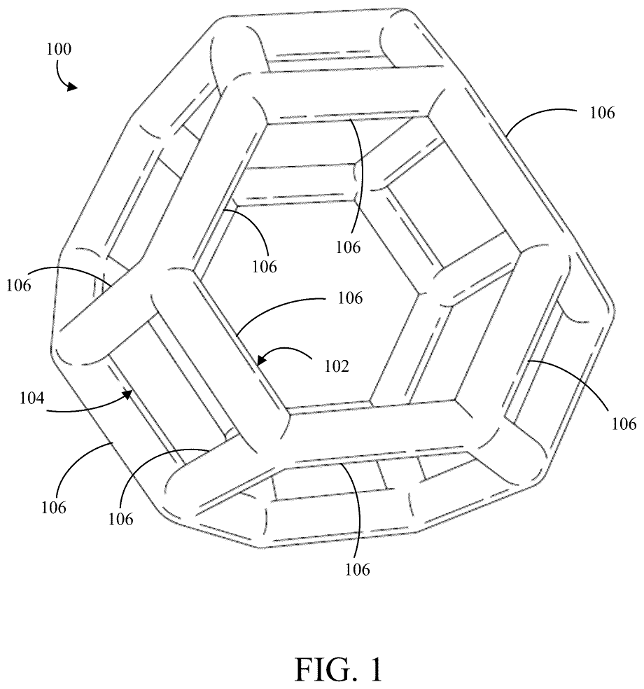

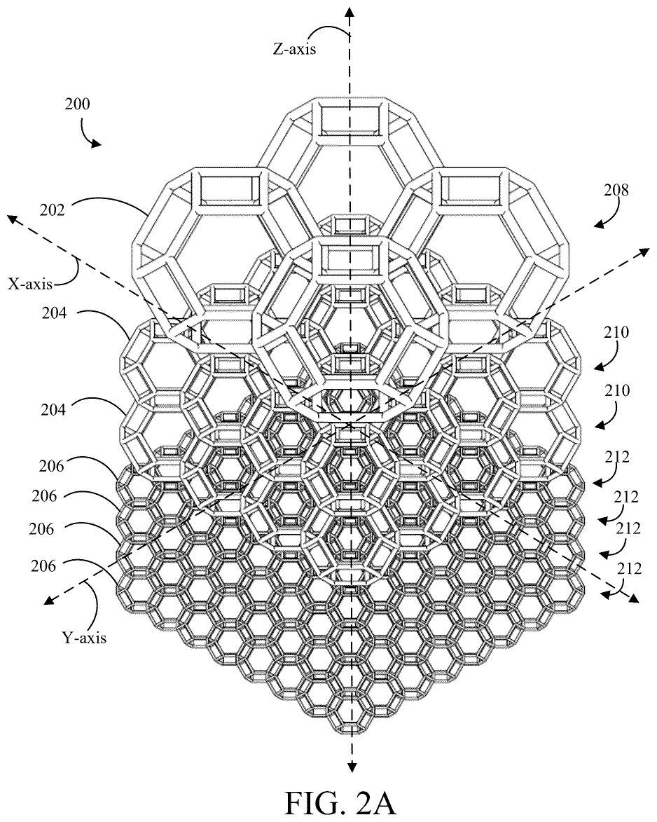

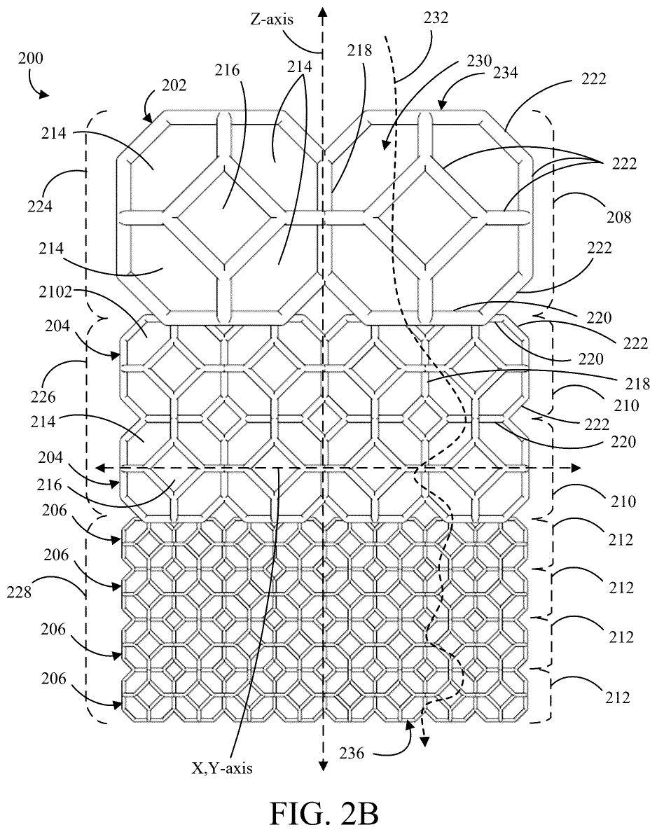

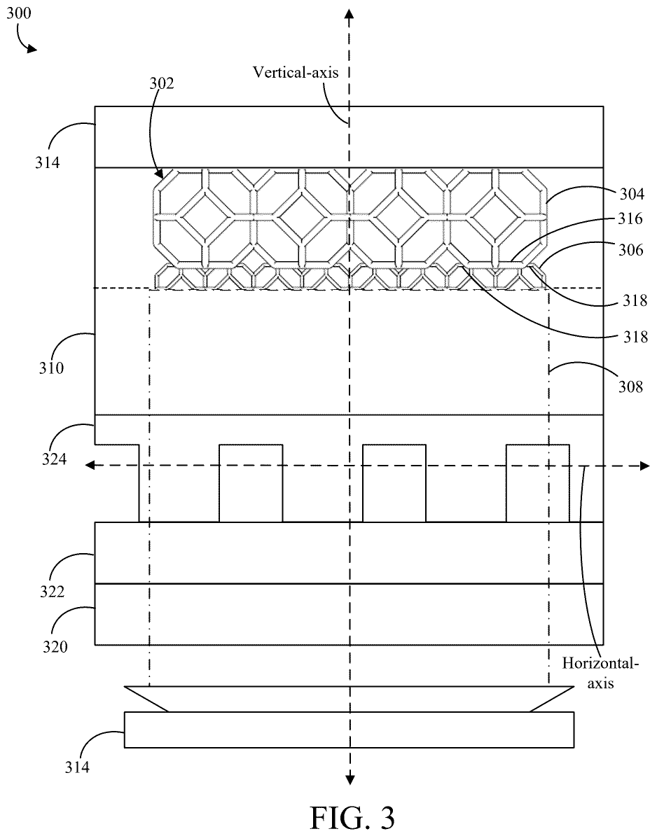

FIG. 1 is a perspective view of a polyhedral frame structure 100. The polyhedral frame structure 100 in this example includes octagonal facets 102 and square facets 104 that in combination form the polyhedral frame structure 100. The polyhedral frame structure 100 includes six of the octagon facets 102 and eight of the square facets 104 such that the polyhedral frame structure 100 has a symmetrical shape. Each of the square and octagon facets 102, 104 include wires 106. The wires 106 are shared between adjacent the square and octagon facets 102, 104, and the wires 106 are uniform in diameter (e.g., along the shortest cross section of the wire 106) throughout the polyhedral frame structure 100. Where two or more of the polyhedral frame structures 100 are connected (e.g., FIGS. 2A-3), the wires 106 may be shared between adjacent of the polyhedral frame structures 100.

FIG. 2A is a perspective view of a structure 200 including a number of polyhedral frame structures 202, 204, 206 that have different sizes (i.e., different diameters and/or volumes). FIG. 2B is side view of the structure 200 of FIG. 2A. The polyhedral frame structures 202, 204, 206 may be similar to the polyhedral frame structure 100 of FIG. 1. Each of the polyhedral frame structures 202, 204, 206 are arranged in respective layers 208, 210, 212 that are stacked on top of each other such that spaces and channels are formed therethrough the octagon and square facets 214, 216 of each of the polyhedral frame structures 202, 204, 206. The octagon and square facets 214, 216 may be similar to the square and octagon facets 102, 104 of FIG. 1.

In each of the layers 208, 210, 212, the polyhedral frame structure 202, 204, 206 of a same diameter and/or volume are arranged along the X and Y axes in one of the layers 208, 210, 212 and each of the layers 208, 210, 212 that may have a diameter and/or volume that is different or the same than the preceding layer are stacked on top of each other along the Z-axis. Along the X and Y axes within each of the layers 208, 210, 212, the polyhedral frame structures 202, 204, 206 are arranged side by side such that polyhedral frame structures 202, 204, 206 are arranged in a row or plane of the layers 208, 210, 212. One of the polyhedral frame structures 202, 204, 206 may contact or be connected with between one and six or more adjacent of the polyhedral frame structures 100, 202, 204, 206 such that the layers 208, 210, 212 and/or structure 200 are desirably formed. Even though the X, Y, and Z-axes are illustrated in FIG. 2A, in other examples, the structure 200 may be rotated and the X, Y, and Z-axes may be positioned elsewhere or each of the layers 208, 210, 212 may be arranged in any two of the X, Y, and Z-axes. The Z-axis may refer to a printing direction, when the structure 200 is formed by an additive manufacturing process (e.g., DLP).

Each of the polyhedral frame structures 202, 204, 206 include layer wires 218 that connect the polyhedral frame structures 202, 204, 206 that are adjacent and/or within one of the layers 208, 210, 212; connection wires 220 that connect the polyhedral frame structures 202, 204, 206 that are adjacent and/or in separate of the layers 208, 210, 212; and intermediate wires 222 that do not connect or overlap with the polyhedral frame structures 202, 204, 206 that are adjacent. Overlap of any of the layer, connection, and/or intermediate wire 218, 220, 220 may mean that a single of the layer, connection, and/or intermediate wire 218, 220, 220 may be shared by a two or more of the polyhedral frame structures 202, 204, 206, such as between and/or within the layers 208, 210, 212.

The layer wires 218 connect two or more adjacent of the polyhedral frame structures 202, 204, 206 that are within one of the layers 208, 210, 212 such that the polyhedral frame structures 202, 204, 206 form one of the layers 208, 210, 212 extended through the X and Y-axes with the polyhedral frame structures 202, 204, 206 having the same diameter and/or volume. The layer wires 218 may be position within one of the layers 208, 210, 212 and free of contact or connection with an adjacent one of the layers 208, 210, 212, such as illustrated in FIGS. 2A-2B. In other examples, the layer wires 218 may contact or connect an adjacent one of the layers 208, 210, 212 at a corner or edge, such as in an example where the layers 208, 210, 212 include the polyhedral frame structures 202, 204, 206 has a shape of a hexahedron (i.e., a cube). The layer wires 218 may generally extend along the Z-axis such that the layer wires 218 may be shared by two of the polyhedral frame structures 202, 204, 206 that are adjacent. The layer wires 218 may be generally perpendicular relative to the connection wires 220. The layer wires 218 may be generally angled (i.e., not perpendicular or parallel) relative to the intermediate wires 222. The layer wires 218 may be described as vertical wires, and the connection wires 220 may be described as horizontal wires, such as when the structure 200 is formed by an additive manufacturing process (e.g., DLP). Any of the layer, connection, and/or intermediate wires 218, 220, 222 may be described as base layer wires, secondary layer wires, subsequent layer wires, base connection wires, secondary connection wires, subsequent connection wires, base intermediate wires, secondary intermediate wires, and/or subsequent intermediate wires,

The connection wires 220 connect at least two of the layers 208, 210, 212 that are adjacent. As illustrated, such as between the layer 208 and a top one of the layers 210, the polyhedral frame structure 202 connects with two of the polyhedral frame structures 204 at connection wires 220, since the polyhedral frame structures 204 have a diameter and/or volume that is less than a volume and/or diameter of the polyhedral frame structures 202 (illustrated as about half of the diameter relative to the polyhedral frame structures 202 as measured along the Z-axis). Similarly, the polyhedral frame structures 206 have a volume and/or diameter that is less than a volume and/or diameter of the polyhedral frame structures 204 (illustrated as about a quarter of the diameter relative to the polyhedral frame structures 202 as measured along the Z-axis).

The connection wires 220 may be shared by any number of polyhedral frame structures 202, 204, 206 between the layers, such as between two and ten of the polyhedral frame structures 202, 204, 206. The connection wires 220 may be connected with the layer wires 218 directly or through one or more of the intermediate wires 222. The connection wires 220 may be parallel with the X and/or Y-axes such that the connection wires 220 can connect two or more polyhedral frame structures 202, 204, 206 within two different of the layers 208, 210, 212. The connection wires 220 may have a cross-sectional diameter (generally measured at two opposing surfaces that are the shortest distance apart) that is consistent along a length of the connection wire 220. In other examples, the connection wires 220 that are overlapping between the polyhedral frame structures 202, 204, 206 that are different sizes (e.g., between the layers 208, 210 or the layers 210, 212) and still overlapped and/or connected. The diameter of the connection wires 220 may be between about 0.1 mm and about 1 cm. The connection wires 220 may have the same or different diameter as the diameter of the layer wires 218 and/or intermediate wires 222.

The diameter of the layer wires 218, the connection wires 220, and the intermediate wires 222 may be similar or different. The diameter of the layer wires 218, the connection wires 220, and the intermediate wires 222 may be adjusted such that sufficient tortuosity is achieved in the structure 200 due to overlapping of the space between the layer wires 218, the connection wires 220, and/or the intermediate wires 222. The diameter of the layer, connection, and intermediate wires 218, 220, 222 may be uniform or non-uniform in all of the polyhedral frame structures 202, 204, 206 within one of the layers 208, 210, 212. The diameter of the layer, connection, and intermediate wires 218, 220, 222 may be sufficiently sized such that channels are formed therein between the octagon and/or square facets 214, 216 and assist with deflecting or bouncing sound waves within the structure 200. In some examples, two of the connection wires 220 of different ones of the polyhedral frame structures 202, 204, 206 may be connected through a fastener, such as an adhesive, a heat weld, or any other means to connect two components.

The intermediate wires 222 connect two more other of the layer wires 218, the connection wires 220, and/or the intermediate wires 222 such that one or more of the octagon and/or square facets 214, 216, other facets (not shown), and/or polyhedral frame structures 202, 204, 26 are formed. The intermediate wires 222 may be any wire that does not connect, contact, or overlap between two of the polyhedral frame structures 202, 204, 206 that are the same. The intermediate wires 222 may extend from either the connection wires 220, the layer wires 218, and/or another of the intermediate wires 222 at any angle sufficient to form a desirable facet or the polyhedral frame structures 202, 204, 206. For example, the angle of extension relative to the layer and/or connection wires 218, 220 of the intermediate wires 222 may be about 5 to about 175 degrees.

The layers 208, 210, 212 are included as groups 224, 226, 228 that include one or more of the layers 208, 210, 212 in each one of the groups 224, 226, 228, respectively. Each of the groups 224, 226, 228 may individually represent one of the layers 208, 210, 212 with one of the polyhedral frame structures 202, 204, 206 that have the same volume and/or diameter. Each of the groups 224, 226, 228 may include between one and ten of the layers 208, 210, 212 that have the polyhedral frame structures 202, 204, 206 having diameters and/or volumes that are the same within each of the groups 224, 226, 228. In some examples, one of the groups 224, 226, 228 may overlap with another of the groups 224, 226, 228 such that two different of the layers 208, 210, 212 at distal ends of the groups 224, 226, 228 are overlapping. The overlap between the layers 208, 210, 212 and/or the groups 224, 226, 228 may be advantageous to increase tortuosity such that more noise is insulated or mitigated across the structure 200 and/or sound waves are deflected at the layer, connection, and/or intermediate wires 218, 220, 222.

Each of the polyhedral frame structures 100, 202, 204, 206 may have any structure sufficient to form the layers 208, 210, 212 and/or the structure 200 such that a stacked formation is formed and is suitable to mitigate sound waves. The polyhedral frame structures 100, 202, 204, 206 may have a volume or diameter sufficient to have the connection wires 218 that are overlapping and/or connected at each of the polyhedral frame structures 100, 202, 204, 206 and without any intervening wires (not shown) between the polyhedral frame structures 100, 202, 204, 206. In other words, each of the layers 208, 210, 212 may connect through the connection wires 218 that define a shape of the polyhedral frame structures 100, 202, 204, 206.

In some examples, intervening wires (not shown) are used between the polyhedral frame structures 100, 202, 204, 206 to form the structure 200. Intervening wires (not shown) may be defined as wires extended from the polyhedral frame structures 100, 202, 204, 206 rather than wires (e.g., the layer, connection, and/or intermediate wires 218, 220, 222) that define the polyhedral frame structures 100, 202, 204, 206.

The volume and/or diameter of the polyhedral frame structures 100, 202, 204, 206 may be configured to allow for the structure 200 to be made from an additive manufacturing process (e.g., DLP; see, FIG. 3). The volume and/or diameter of each of the polyhedral frame structures 100, 202, 204, 206 may be different between polyhedral frame structures 100, 202, 204, 206 of different of the layers 208, 210, 212, as illustrated in FIGS. 2A-2B. The volume of each of the polyhedral frame structures 100, 202, 204, 206 may be about 1 mm³, 20 mm³, or 100 mm³ to about 1 cm³, 50 cm³, or 500 cm³. Volume may be measured as space between the layer, connection, and intermediate wires 218, 220, 222 and/or space between the square and octagon facets 214, 216. Volume may be measured by any technique suitable for each of the polyhedral frame structures 100, 202, 204, 206 known by the skilled artisan in the art. Diameter of the polyhedral frame structures 100, 202, 204, 206 may be about 0.1, 1, 10, 50 mm to about 1, 5, 10, or 20 cm. Diameter may be measured as the distance between two opposing surfaces (e.g., opposing facets or wires) of the polyhedral frame structures 100, 202, 204, 206.

In FIGS. 2A-2B, the diameter of each of the polyhedral frame structures 202, 204, 206, at least in part, may assist with desirable alignment of the layers 208, 210, 212. For example, the diameter of the polyhedral frame structure 204 is about half of the diameter of the polyhedral frame structures 202 such that some of the layer, connection, and/or intermediate wires 218, 220, 222 of the polyhedral frame structure 204 obstruct some of the octagon and/or square facets 214, 216 of the polyhedral frame structures 202. Similarly, the diameter of the polyhedral frame structures 206 is about half of the diameter of the polyhedral frame structures 204 (or about a quarter of the diameter of the polyhedral frame structures 202) to achieve a similar effect as the relationship of the polyhedral frame structures 202, 204. With this arrangement of polyhedral frame structures 202, 204, 206 that are halved (either in diameter or volume) between the groups 224, 226, 228, the tortuosity of the structure 200 is increased and the polyhedral frame structures 202, 204, 206 connect between layers without any intervening wires (not shown) such that the structure can be effectively built or made layer by layer, such as by digital light processing.

Each of the polyhedral frame structures 100, 202, 204, 206 may have any structure sufficient to form the layers 208, 210, 212 and/or the structure 200 such that a stacked formation is formed and is suitable to mitigate sound waves. The polyhedral frame structures 100, 202, 204, 206 may have a shape sufficient to form one or more of the layers 208, 210, 212 with overlapping or non-overlapping portions in the X and/or Y-axes. For example, some of the polyhedral frame structures 100, 202, 204, 206 may have portions other than connection wires 220 that overlap within along the X and/or Y-axes and at a point along the Z-axis. In some examples, the polyhedral frame structures 100, 202, 204, 206 do not have portions or wires that overlap in the X and/or Y-axes other than the connection wires 220. The facets of each of the polyhedral frame structures 202, 204, 206 may define the shape of the polyhedral frame structures 202, 204, 206. The polyhedral frame structures 100, 202, 204, 206 may have a shape that is symmetrical or asymmetrical. Examples of polyhedral frame structures 100, 202, 204, 206 may include one or more of a tetrahedron, hexahedron, octahedron, dodecahedron, icosahedron, truncated tetrahedron, truncated hexahedron, truncated octahedron, truncated dodecahedron, truncated icosahedron, cuboctahedron, icosidodecahedron, rhombicosidodecahedron, great icosahedron, great dodecahedron, snub cube, snub dodecahedron, pentakis dodecahedron, stellated octahedron, great rhombicosidodecahedron, any other symmetrical or non-symmetrical shape sufficient for stacking in or on the layers 208, 210, 212, or any combination thereof.

The structure 200 may include any number of the polyhedral frame structures 202, 204, 206 and/or layers 208, 210, 212 sufficient to form channels 230 therethrough the structure 200 so that the noise or sound waves 232 can enter the structure 200. For example, each of the layers 208, 210, 212 may include between about 2 and about 200 of the polyhedral frame structures 202, 204, 206. As discussed throughout, since the polyhedral frame structures 202, 204, 206 have varying diameters and/or volumes, the layer, connection, and/or intermediate wires 218, 220, 222 between the groups 224, 226, 228 overlap such that the channel 230 has a relatively high tortuosity from an entry side 234 to an exit side 236. In other examples, the entry or exit sides 234, 236 may be any other side of the structure 200 where noise or sound waves enter or exit the structure 200. The tortuosity of the structure 200 may be measured from an entry and/or exit sides 234, 236.

Although not illustrated in FIGS. 2A-2B, the polyhedral frame structures 202, 204, 206 may vary in diameter and/or volume relative to each other to form layers 208, 210, 212 of a different arrangement. For example, the layer 208 on top may have polyhedral frame structures 202 that may have a diameter and/or volume that is the same as the polyhedral frame structures 206 in the layer 212 on the bottom. In other examples, other layers (not shown) of varying sizes are included in the structure 200 such that the channels 230 formed therebetween the layers 208, 210, 212 have a higher tortuosity and, thus, a higher capability to insulate sound.

The polyhedral frame structures 100, 202, 204, 206 may have a shape, volume, diameter, and/or size ratio that is different between the layers 208, 210, 212 that is sufficient to introduce desirable tortuosity in the channels between the layer, connection, and intermediate wires 218, 220, 222 of the polyhedral frame structures 100, 202, 204, 206. As discussed throughout, each of the polyhedral frame structures 100, 202, 204, 206 are hollow because the polyhedral frame structures 100, 202, 204, 206 are frame structures defined by the layer, connection, and intermediate wires 218, 220, 222. The channels formed therethrough the polyhedral frame structures 100, 202, 204, 206 extend through the octagon and/or square facets 214, 216 (which may be other shaped facets in the polyhedral frame structures 100, 202, 204, 206 with different shapes).

The stacking of the layers 208, 210, 212 with the polyhedral frame structures 100, 202, 204, 206 of different sizes causes the layer, connection, and intermediate wires 218, 220, 222 and the octagon and/or square facets 214, 216 to overlap along one or more of the X, Y, and/or Z axes such that sound waves moving through the polyhedral frame structures 100, 202, 204, 206 are deflected or impaired by layer, connection, and intermediate wires 218, 220, 222 and the octagon and/or square facets 214, 216 and, thus, reduce sound transmission from one side to another of the structure 200. Between the layers 208, 210, 212 and each of the polyhedral frame structures 100, 202, 204, the tortuosity is high because of the overlap along one or more of the X, Y, and/or Z axes. The tortuosity of the structure 200 may be measured from one of the entry sides (e.g., the entry side 234) of the structure 200 to a terminal or distal side (e.g., the exit side 236) of the structure 200 that may be parrel with, angled to, and/or perpendicular relative to the entry surface. Entry sides may be any surface on the structure that is exposed to any external environment and/or where sound enters the structure 200. When measuring tortuosity, the terminal or distal sides may be any surface that is not the entry surface, whether exposed to the external environment or not. Tortuosity of the structure 200 may be greater than 1. Tortuosity of the structure 200 may be a number greater than 1, 3, 5, or 10 to about 50, 100, or 500. Tortuosity may be calculated through known methods in the art to determine winding of a particular channel.

The layers 208, 210, 212 may be described as base, secondary, and/or subsequent layers. Base layers may mean that the layer is the primary layer that one or more other layers are connected with or built upon, such as during an additive manufacturing process. Secondary layers may mean a layer that connects with the base layer. Subsequent layer may be layers connected with our built upon the base and/or secondary layers. Subsequent and/or secondary layers may have diameters or volume that are different than the same as the base layer.

The structure 200 may be formed from one or more materials sufficient to form the structure 200 and insulate sound. The materials used in the structure 200 may be formed as a single piece through an additive manufacturing technique or another technique. The structure 200 may include a combination of materials that may be connected through fasteners (e.g., welds, adhesives, ties, or the like or any combination thereof). The structure 200 may include a combination of materials to realize different or uniform properties in different of the layers 208, 210, 212. For example, it may be advantageous to have an external layer having high rigidity and an internal layer with high flexibility relative to the external layer. In other examples, the combination of materials may be selected such that sufficient properties are achieved along parts or all of the structure. For example, desirable properties may include high fire resistance, thermal resistance, Charpy impact resistance, elastic modulus, elongation at break, flexural modulus, density, porosity, or any combination thereof.

The structure 200 may be made of a material sufficient to be used in additive manufacturing. For example, a precursor material may be fused together through application of heat or ultraviolet light such that the precursor material forms the structure 200. Examples of forming the structure through such techniques may include additive manufacturing, such as digital light processing (DLP). The precursor material may be comprised of appropriate monomers, oligomers, and/or polymers in a form sufficient to be polymerized (or otherwise further reacted) under heat or ultraviolet light such that the structure 200 is formed. The structure 200 may be formed by applying heat or ultraviolet light selectively to form individual of the polyhedral frame structures 202, 204, 206 one at a time or by applying heat or ultraviolet light such that the layers 208, 210, 212 are formed one at a time.

The material of the structure 200 may include a photocurable resin composition suitable for use in additive manufacturing processes, such as digital light processing (DLP) processes. DLP may involve the selective curing of a liquid resin layer-by-layer using a light source, such as a digital light projector, to form a three-dimensional object (see e.g., FIG. 3). In other examples, other additive manufacturing processes may be used to cure the material of the structure, such as by stereolithography, liquid crystal display printing, material jetting, fused filament fabrication, continuous liquid interface production, binder jetting, selective laser sintering, multi jet fusion, or any combination thereof. The material of the structure 200 may be selected such that it is suitable for the selected additive manufacturing processes and also have one or more of the aforementioned properties. Whether an additive manufacturing process or other process is used (e.g., molding, casting, forging, electrical discharge machining, computer numerical control, or any combination thereof), any suitable polymer or resin may be used to form the structure 200 such that the structure 200 has desirable sound insulation properties between two areas or objects.

The photocurable resin composition may include one or more photopolymerizable monomers, oligomers, and/or polymers, one or more photo initiators, and/or one or more additives. The one or more photopolymerizable monomers, oligomers, and/or polymers, one or more photo initiators, and/or one or more additives may be included in any amounts or ratios sufficient to achieve desirable properties and to be cured upon exposure to ultraviolet light (at any desirable wavelength) and/or heat.

The photopolymerizable monomer or oligomer may be present in an amount of about 40 to 99 weight percent, based on the total weight of the photocurable resin composition. The photopolymerizable monomer or oligomer may include methacrylates, urethane acrylates, epoxy acrylates, polyester acrylates, and combinations thereof. For example, the monomer may comprise a multifunctional acrylate, such as trimethylolpropane triacrylate (TMPTA) or dipentaerythritol pentaacrylate (DPHPA), which provides a high degree of crosslinking and enhances the mechanical strength of the printed object. Oligomers, which are higher molecular weight precursors, may be incorporated to impart specific properties to the cured photocurable resin. Some oligomers may include urethane acrylates, epoxy acrylates, polyester acrylates, and silicone acrylates. Urethane acrylates, for instance, may be particularly advantageous due to their versatility, offering a range of hardness and elasticity depending on the molecular structure of the urethane backbone. Oligomers as described here may have a molecular weight (e.g., number average and/or weight average molecular weight) of about 500 to 5,000 g/mol may be used to achieve a balance of toughness and flexibility, making it suitable for applications such as flexible hinges or impact-resistant components. Epoxy acrylates may have chemical resistance and adhesion, which are beneficial for industrial parts or coatings. In some examples, certain polymers may be mixed within the photocurable composition and chain extended, end capped, branched, crosslinked, or any combination thereof upon application of the heat and/or ultraviolet light. Further examples of photocurable resin compositions may be described in U.S. Pat. No. 6,200,732B1 and U.S. Pat. No. 8,878,169B2, which are each incorporated herein by reference in their entirety.

The photoinitiator may present in an amount ranging from about 0.1% to about 20% by weight of the total composition. Suitable photoinitiators include, but are not limited to, phenylbis(2,4,6-trimethylbenzoyl)phosphine oxide (BAPO), 2-hydroxy-2-methylpropiophenone, and camphorquinone. The photoinitiator may be selected to efficiently absorb light at the wavelength emitted by the DLP light source, thereby initiating the polymerization reaction with minimal latency.

The photocurable resin composition may further include a viscosity modifier to adjust the flow characteristics of the liquid resin, ensuring uniform layer formation during the printing. For instance, a low-viscosity monomer such as isobornyl acrylate may be added to reduce the overall viscosity to a desirable range (e.g., about 50 cP to about 500 cP at 25° C., as measured by a standard rheometer). This desirable range may facilitate rapid recoating of the photocurable resin composition between layers while maintaining sufficient stability to prevent unwanted flow or distortion during the printing process.

The resin composition may also include one or more stabilizers, such as hindered amine light stabilizers (HALS) or phenolic antioxidants, to prevent premature polymerization during storage and to enhance the shelf life of the resin. Additionally, fillers and/or fibers such as silica nanoparticles or glass fibers may be incorporated in an amount ranging from about 1% to about 20% by weight to improve the mechanical properties, such as tensile strength and thermal resistance, of the cured object.

FIG. 3 illustrates an example technique to form the structures 200 of FIGS. 2A-2B. Of course in other examples, the structures 200 of FIGS. 2A-2B may be formed by other techniques and may be comprised of different shapes, such as those described in relation to polyhedral frame structures 100, 202, 204, 206 of FIGS. 1-2A.

This technique of FIG. 3 includes a digital light printer 300 that is configured to form a structure 302 by DLP. The digital light printer 300 builds the structure 302 layer 304 by layer 306 by applying ultraviolet light 308 to the liquid resin 310 (e.g., photocurable resin composition) through an ultraviolet light projector 312 (e.g., a LED or mercury lamp). The ultraviolet light projector 312 may apply light to the liquid resin 310 for any period of time sufficient to react the photocurable resin composition of the liquid resin 310 and form portions of the structure 302. For example, each of the layers 304, 30 may be formed from application of ultraviolet light 308 from 1 second to about 100 seconds, which may depend on the thickness of each of the layers 304, 306. The layers 304, 306 each include polyhedral frame structures of the same diameter and/or volume within each of the layers 304, 306. For example, the structure 302 may include similar portions as the polyhedral frame structures 100, 202, 204, 206 of FIGS. 1-2B. An entire one or portions of the layers 304, 306 may be formed during a cycle of ultraviolet light 308 projection.

Generally, the layers 304, 306 are built along a horizontal axis on a support 314 that is configured to connect with the structure 302 and move along the vertical-axis (up and down) such that a uniform design is formed at each of the layers 304, 306. The support 314 may be any size to support a desirably sized structure 302. Between the layers 304, 306, the layer 304 has connection wires 316 and the layer 304 has wires connection 318 that overlap and are connecting the layers 304, 306, which allows for the layers 304, 306 to be formed one by one while being connected to the preceding of the layer.

The ultraviolet light projector 312 is configured to emit the ultraviolet light 308 through the glass layer 320 and the polydimethyl siloxane layer 322 to the liquid resin 310 such that the structure 302 is formed. The glass and polydimethyl siloxane layers 320, 322 may be any thickness sufficient to allow the ultraviolet light 308 to desirably cure the liquid resin 310. Between the liquid resin 310 and the polydimethyl siloxane layer 322, an oil 324 is positioned to avoid and/or mitigate sticking between the polydimethyl siloxane layer 322 and the liquid resin 310 once cured.

The above shows one example of a technique using a digital light printer 300. In some examples, digital light printers of a different type may be utilized. Examples of digital light printers may include one or more of standard digital light printers, top-down digital light printers, bottom-up digital light printers, continuous digital light printers, high-resolution digital light printers, industrial digital light printers, LCD-Based digital light printers, or any other digital light printers configured to print layer by layer to form the structure 302.

The structures 200, 302 described herein may be utilized in any apparatus or location where sound insulation is desired. For example, the structures 200, 302 may be placed between a motor and a hood or motor housing of a car and the external paneling such that sound is mitigated from the external environment. The structures 200, 302 may be integrated into panels within a vehicle to mitigate sound within a cabin of a vehicle. In another example, the structures 200, 302 may be integrated in walls of a room to mitigate sounds between adjacent rooms or buildings (e.g., in recording studios, office spaces, warehouses, factories, hospital rooms, airports, etc.). The structures 200, 302 may at least partially encase a motor or housing for a generator.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A structure, comprising:
a base layer comprising base polyhedral frame structures that are connected with each other at base layer wires of the base polyhedral frame structures; and
a secondary layer comprising secondary polyhedral frame structures that are each connected with the base layer at connection wires of the base and secondary polyhedral frame structures, wherein the secondary polyhedral frame structures each have a secondary volume that is less than a base volume each of the base polyhedral frame structures.

2. The structure of claim 1, wherein the base layer has a base diameter that is larger than a secondary diameter of the secondary layer.

3. The structure of claim 2, wherein the base diameter is at least twice as large as the secondary diameter.

4. The structure of claim 1, wherein the secondary polyhedral frame structures are connected with each other within the secondary layer by overlapping secondary layer wires.

5. The structure of claim 4, wherein the base layer wires and the secondary layer wires each separately define layer facets that connect with the connection wires of the base and secondary polyhedral frame structures by intermediate wires.

6. The structure of claim 1, wherein the base and secondary polyhedral frame structures have a shape that is the same.

7. The structure of claim 6, wherein the base and the secondary polyhedral frame structures each have a shape that is symmetrical.

8. The structure of claim 7, wherein the base and the secondary polyhedral frame structures each comprise square and octagonal facets.

9. The structure of claim 8, wherein the base and secondary polyhedral frame structures each have a shape of a truncated octahedron.

10. The structure of claim 1, further comprising:
one or more subsequent layers each comprising subsequent polyhedral frame structures that are connected with the secondary layer or a preceding layer of the one or more subsequent layers by subsequent connection wires of the secondary polyhedral frame structures and/or the subsequent polyhedral frame structures.

11. The structure of claim 1, wherein at least some of the subsequent polyhedral frame structures have a subsequent volume that is less than the secondary volume of each of the secondary polyhedral frame structures.

12. A structure, comprising:
a base layer comprising base polyhedral frame structures that are connected with each other within the base layer; and
one or more subsequent layers each comprising subsequent polyhedral frame structures that are connected with each other within individual layers of the one or more subsequent layers, wherein each of the individual layers of the one or more subsequent layers are connected with the base layer or a preceding layer of the one or more subsequent layers,
wherein the base layer and the one or more subsequent layers in combination define channels between connection, layer, and intermediate facets of base layer and the one or more subsequent layers having a tortuosity of greater than 1.

13. The structure of claim 12, wherein the tortuosity is measured as a distance between an initial facet of the base layer and a distal facet of a terminal layer of the one or more subsequent layers.

14. The structure of claim 12, wherein the base layer has a base diameter that is at least twice as large as a subsequent diameter of each of the one or more subsequent layers.

15. The structure of claim 14, wherein the preceding layer of the one or more subsequent layers has a preceding diameter that is at least twice as large as a succeeding diameter of a succeeding layer of the one or more subsequent layers.

16. The structure of claim 12, wherein the base polyhedral frame structures are connected with each other at layer facets within the base layer, wherein the subsequent polyhedral frame structures are connected with each other at the layer facets within each of the individual layers of one or more subsequent layers, and wherein the base polyhedral frame structures and/or the one or more subsequent polyhedral frame structures are connected with each other at connection facets that are partially located within the base layer and/or the one or more subsequent layers.

17. A method of additive manufacturing, comprising:
curing a base layer comprising base polyhedral frame structures connected with each other at base layer wires; and
curing one or more subsequent layers comprising subsequent polyhedral frame structures connected with each other at subsequent layer wires, wherein the one or more subsequent layers are connected with the base layer or a preceding layer of the one or more subsequent layers at connection wires of the base polyhedral frame structures and/or the subsequent polyhedral frame structures of the preceding layer, and wherein at least some of the one or more subsequent layers have a subsequent diameter that is less than a base diameter of the base layer.

18. The method of claim 17, wherein the base diameter is at least twice as large as the subsequent diameter.

19. The method of claim 17, wherein the base layer wires and the subsequent layer wires each separately define layer facets that form a pattern that is horizontally aligned.

20. The method of claim 17, wherein the base polyhedral frame structures and the subsequent polyhedral frame structures have a shape that is symmetrical.
